(19) United States
(12) Patent Application Publication
(10) Pub. No.: US 2025/0156762 A1
(43) Pub. Date: May 15, 2025

(54) ENERGY EFFICIENT MACHINE LEARNING ON THE EDGE WITH QUERY-BASED KNOWLEDGE ASSISTANCE

(71) Applicant: SRI International, Menlo Park, CA (US)

(72) Inventors: Aswin NADAMUNI RAGHAVAN, Pennington, NJ (US); David Chao ZHANG, Belle Mead, NJ (US); Saurabh FARKYA, Jersey City, NJ (US); Zachary Alan DANIELS, Robbinsville, NJ (US); Michael PIACENTINO, Southern Shores, NC (US); Gooitzen S. VAN DER WAL, Hopewell, NJ (US); Philip MILLER, Yardley, PA (US); Michael Richard LOMNITZ, Castro Valley, CA (US); Abrar Abdullah RAHMAN, Brooklyn, NY (US); Edison MUCLLARI, Hamilton Township, NJ (US); Muhammad Shahir RAHMAN, Portland, OR (US)

(21) Appl. No.: 18/944,744

(22) Filed: Nov. 12, 2024

Related U.S. Application Data
(60) Provisional application No. 63/598,321, filed on Nov. 13, 2023.

(51) Int. Cl. G06N 20/00

(52) U.S. Cl. CPC G06N 20/00

(57) ABSTRACT

A method, apparatus, and system for efficient machine learning with query-based knowledge assistance includes determining a state of data captured by a sensor in communication with a first edge device to determine if the captured data includes data that is out of distribution based on a trained inference model of the first edge device, if it is identified that an amount of out of distribution data in the captured data is preventing the trained inference model from making an accurate prediction, communicating a request for resources to a second edge device or a server to elicit a response from the second edge device or the server including resources required to update the trained inference model, receiving the requested resources, updating the trained inference model using the received resources, and making a prediction for the received captured data using the updated, trained inference model.

### CROSS-REFERENCE TO RELATED APPLICATIONS

This application claims benefit of and priority to U.S. Provisional Patent Application Ser. No. 63/598,321, filed Nov. 13, 2023, which is herein incorporated by reference in its entirety.

### GOVERNMENT RIGHTS

This invention was made with Government support under contract number 2022-2110060000 awarded by IARPA. The Government has certain rights in this invention.

### FIELD OF THE INVENTION

Embodiments of the present principles generally relate to communications and machine learning training on edge devices and, more particularly, to a method, apparatus and system for providing efficient communication between at least one edge device and remote servers, such as the cloud, for efficient training of machine learning models on edge devices using energy efficient data sources.

### BACKGROUND

Edge devices comprise low-compute/low-energy devices that require training of machine learning-based domain experts. In some instances on such devices, data collection and model training is performed on-device, but data labeling is performed by querying a centralized server with access to enhanced knowledge, for example when out-of-distribution data is received at the edge device. That is, currently, when out-of-distribution data is received at an edge device, the edge device no longer has the means to locally label data. In addition, the bandwidth between the edge devices and the centralized server is not unlimited and, as such, data labeling has to be performed efficiently and on a limited capacity using, for example, energy efficient databases.

As such, there is a need for a method, apparatus, and system for solving the technical problem of how to efficiently use available bandwidth between at least one edge device and a data source, such as other edge devices and/or a server, such as the cloud, for communicating necessary data from the data source to the edge device for efficiently training machine learning systems at the edge device for enabling the edge device to perform accurate predictions when receiving out-of-distribution data.

### SUMMARY

Embodiments of the present principles provide a method, apparatus, and system for efficient machine learning with query-based knowledge assistance on edge devices.

In some embodiments, a method for efficient machine learning with query-based knowledge assistance on edge devices includes receiving data captured by at least one sensor in communication with the first edge device, determining a state of the captured data to determine if the captured data includes data that is out of distribution based on a trained inference model of the first edge device, if the determined state identifies that an amount of out of distribution data in the captured data is preventing the trained inference model from making an accurate prediction from the captured data, determining a request for resources to be communicated to at least one of a second edge device or a server, communicating the request for resources to the at least one of the second edge device or the server to elicit a response from the at least one of the second edge device or the server including resources required to update the trained inference model to enable the updated trained inference model to make an accurate prediction from the captured data, receiving the requested resources, updating the trained inference model using the received resources to enable the updated trained inference model to make an accurate prediction from the captured data, and making a prediction for the received captured data using the updated, trained inference model.

In some embodiments, an apparatus for efficient machine learning with query-based knowledge assistance on edge devices includes a processor and a memory accessible to the processor. In such embodiments, the memory has stored therein at least one of programs or instructions, which when executed by the processor configures the apparatus to receive data captured by at least one sensor in communication with the first edge device, determine a state of the captured data to determine if the captured data includes data that is out of distribution based on/with a trained inference model of the first edge device, if the determined state identifies that an amount of out of distribution data in the captured data is preventing the trained inference model from making an accurate prediction from the captured data, determine a request for resources to be communicated to at least one of a second edge device or a server, communicate the request for resources to the at least one of the second edge device or the server to elicit a response from the at least one of the second edge device or the server including resources required to update the trained inference model to enable the updated trained inference model to make an accurate prediction from the captured data, receive the requested resources, update the trained inference model using the received resources to enable the updated trained inference model to make an accurate prediction from the captured data, and make a prediction for the received captured data using the updated, trained inference model.

In some embodiments, a system for efficient machine learning with query-based knowledge assistance on an edge device includes a server, a database in communication with the server, a network of edge devices, including at least two edge devices, wherein each edge device includes at least one sensor in communication and wherein each edge device includes a processor and a memory accessible to the processor. In such embodiments, the memory has stored therein at least one of programs or instructions that when executed by the processor configure a first edge device of the network of edge devices to receive data captured by at least one sensor in communication with the first edge device, determine a state of the captured data to determine if the captured data includes data that is out of distribution based on/with a trained inference model of the first edge device, if the determined state identifies that an amount of the out of distribution data in the captured data is preventing the trained inference model from making an accurate prediction from the captured data, determine a request for resources to be communicated to at least one of a second edge device of the network of edge devices or the server, communicate the request for resources to the at least one of the second edge device or the server to elicit a response from the at least one of the second edge device or the server including resources required to update the trained inference model to enable the updated trained inference model to make an accurate prediction from the captured data, receive the requested resources, update the trained inference model using the received resources to enable the updated trained inference model to make an accurate prediction from the captured data, and make a prediction for the received captured data using the updated, trained inference model.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1A depicts a high-level block diagram of a federated learning edge device query-based knowledge assisted machine learning system in accordance with at least one embodiment of the present principles.

FIG. 1B depicts a high-level block diagram of an edge device query-based knowledge assisted machine learning system in accordance with at least one alternate embodiment of the present principles in which the edge devices are capable of intercommunication.

FIG. 1C depicts a high-level block diagram of an edge device query-based knowledge assisted machine learning system in accordance with at least one alternate embodiment of the present principles.

FIG. 2A depicts a high-level block diagram of an edge device in accordance with at least one embodiment of the present principles.

FIG. 2B depicts a high-level block diagram of an edge device and its functionality in accordance with at least one embodiment of the present principles.

FIG. 2C depicts an embodiment of a portion of an edge device of the present principles and its functionality in accordance with an alternate embodiment of the present principles.

FIG. 3 depicts a graphical representation of a process that can take place at a centralized server in response to an edge query in accordance with at least one embodiment of the present principles.

FIG. 4 depicts a high-level block diagram of a database 315 of the present principles in accordance with at least one embodiment of the present principles.

FIG. 5 depicts a high-level block diagram of an experimental embodiment of a full system architecture of an edge device query-based knowledge assisted machine learning system in accordance with an embodiment of the present principles.

FIG. 6 depicts a flow diagram of a flow diagram of a method 600 for efficient machine learning with query-based knowledge assistance on an edge device in accordance with at least one embodiment of the present principles.

FIG. 7 depicts a high-level block diagram of a computing device suitable for use with embodiments of an edge device query-based knowledge assisted machine learning system of the present principles in accordance with at least one embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for efficient machine learning with query-based knowledge assistance on edge devices. It should be understood however, that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific edge devices and machine learning models for learning specific multimedia content, embodiments of the present principles can be implemented with substantially any edge device and any machine learning models for learning other types of content, including tasks.

In the description herein, the term “resource(s)”, when described in relation to a resource(s) requested from a server, is intended to describe any data, information, update, etc., available to a source of data, such as an edge device or a server, that are required to update an inference model of, for example, an edge device to enable the inference model to make correct/accurate predictions from at least one of received and/or captured information, such as adaptors, data, weights, labels, models, model updates and the like, required by an inference model to make accurate/correct predictions from received data.

In the description herein, the term “state”, when described in relation to a state of captured data, is intended to describe a characteristic of captured data as it relates to an amount of out-of-distribution data in captured data and an evaluation of resources required to augment the captured data to enable a pretrained inference model to make a correct/accurate prediction using the augmented resources and the captured data.

In the description herein, the term “heterogeneous” is intended to define instances in which exist at least one of different size models, different platforms, different data, and/or different tasks.

Embodiments of the present principles include edge devices that perform a prediction task (e.g., image recognition, object detection, object tracking, scene graph extraction, task evaluation etc.) over streaming data. In such embodiments, over time, the characteristics of the data captured at the edge device can change (e.g., as the season shifts from summer to winter) and a machine learning model of the edge device may need to adapt (i.e., be retrained or augmented to learning on snowy imagery) to make correct/accurate predictions using the changed, captured data. In such embodiments, the models of the edge device efficiently query a data source, such as another edge device and/or a server, when the data becomes out-of-distribution for the trained model of the edge device, and the edge device subsequently adapts the machine learning model of the edge device based on resources (e.g., weights, data, labels/feedback/advice/adaptors/pretrained models) received from the data source in response to the query/request from the edge device. In some embodiments of the present principles, a framework is provided for managing the communication between an edge device and a data source, such as another edge device and/or a server, based on reinforcement learning. Such a framework considers low-computation on the edge device, limited visibility between the edge device and a data source, and communication limits between the edge and the data source (i.e., in some instances data collection at the edge far surpasses a source-edge link capacity).

In some embodiments, a network of edge devices can comprise an efficient foundational model. In such embodiments, the network of edge devices can comprise a combination of at least one large model and some smaller models, which result in energy savings when being trained or when being used for inference over a typical configuration of using a single or multiple large models. In some embodiments of the present principles, a foundational model created from the network of edge devices can use a server as the large model or an aggregation model (described in greater detail below).

Embodiments of the present principles can be applied in many technical fields including but not limited to applications in intelligence, surveillance and reconnaissance (ISR) in which low-compute devices, such as autonomous vehicles, collect, share, and process data for at least one of intelligence purposes, processing of data from remote sensors with limited compute (e.g., satellites, remote sensing for agriculture applications in which environmental conditionals change over time), task performance (e.g., auto repair), and distributed medical care (e.g., medical imaging in which novel medical conditions such as COVID-19 appear over time).

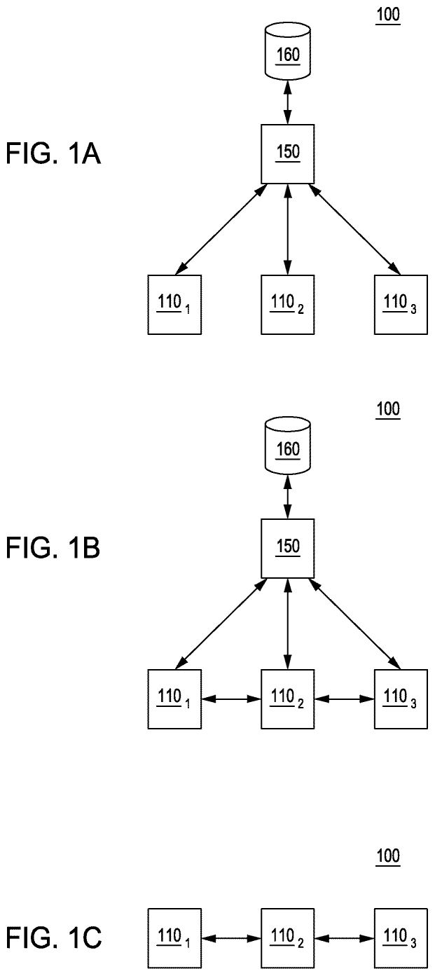

FIG. 1A depicts a high-level block diagram of a federated learning edge device query-based knowledge assisted machine learning system 100 in accordance with at least one embodiment of the present principles. The edge device query-based knowledge assisted machine learning system 100 of FIG. 1 illustratively comprises at least one edge device 110 (illustratively three (3) edge devices 110₁, 110₂, 110₃) and a server 150 (illustratively a Cloud server). In the embodiment of FIG. 1A, the centralized server 150 is in communication with a database 160.

FIG. 1B depicts a high-level block diagram of an edge device query-based knowledge assisted machine learning system 100 in accordance with at least one alternate embodiment of the present principles in which the edge devices are capable of intercommunication. More specifically, in the embodiment of FIG. 1B the edge devices 110₁, 110₂, 110₃ are capable of sharing information and resources as well as with the server 150.

FIG. 1C depicts a high-level block diagram of an edge device query-based knowledge assisted machine learning system 100 in accordance with at least one alternate embodiment of the present principles. In the embodiment of FIG. 1C, the edge devices 110₁, 110₂, 110₃ share information with each other without the need for there to exist a server or a database.

In the embodiments of the edge device query-based knowledge assisted machine learning systems of FIGS. 1A, 1B, and 1C, the edge devices 110₁, 110₂, 110₃ can comprise a network of edge devices, where each edge device is a node and/or separate agent and wherein the network comprises an agentic architecture.

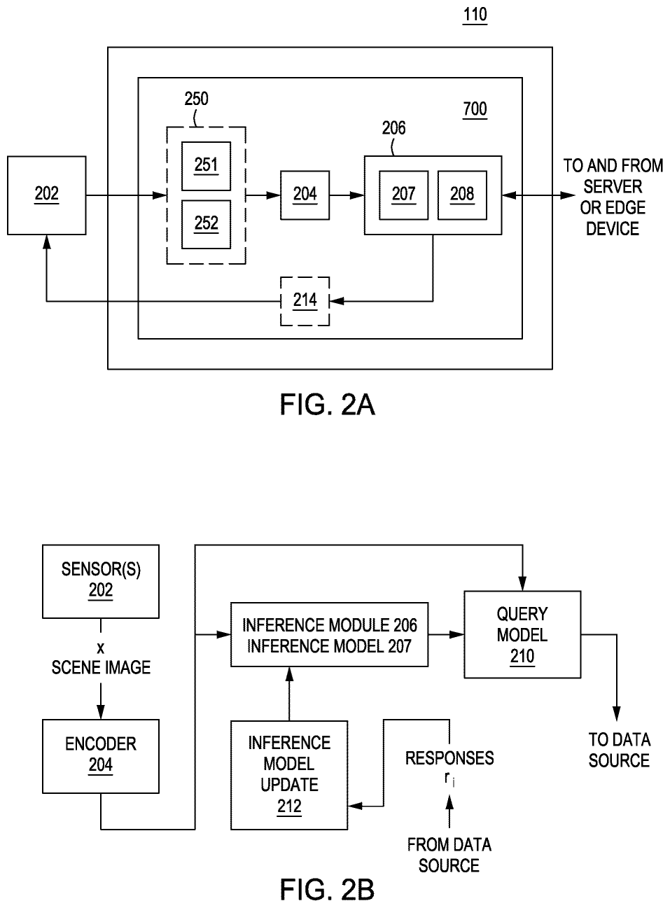

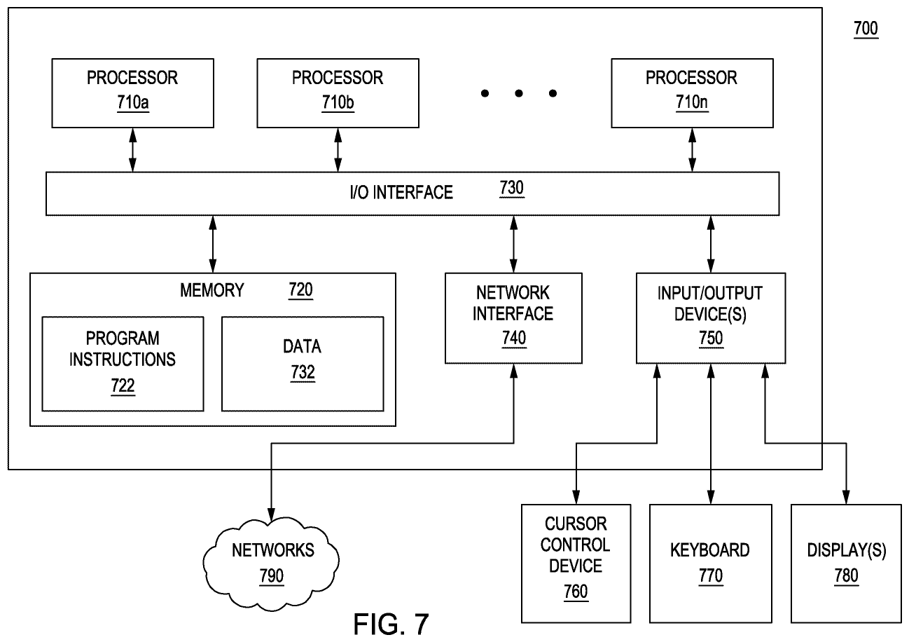

FIG. 2A depicts a high-level block diagram of an edge device 110 in accordance with at least one embodiment of the present principles. The edge device 110 of FIG. 2A illustratively comprises an optional data analyzer 250, illustratively including a scene graph generator 251 and a scene caption generator 252, at least one encoder 204, an inference module 206, including an inference model 207 and a resource determination model 208, and an optional sensor adjustment module 214. As depicted in the embodiment of FIG. 2A, the edge device 110 can receive captured data from at least one sensor 202. Although in the embodiment of FIG. 2A, the at least one sensor is depicted as being a separate component of the edge device 110, in some embodiments of the present principles, the at least one sensor 202 can comprise an integrated component of the edge device 110. As depicted in FIG. 2A, in some embodiments, an edge device of the present principles, such as the edge device 110, can include a computing device 700 (described in greater detail with reference to FIG. 7).

FIG. 2B depicts a functional diagram of an edge device of the present principles, such as the edge device 110 of the edge device query-based knowledge assisted machine learning system 100 of FIGS. 1A and 1B in accordance with at least one embodiment of the present principles. In the embodiment of the edge device 110 of FIG. 2B, the at least one sensor 202 captures a scene image, x. The scene image, x, is communicated to the encoder 204, which determines latent features, z, of the objects in the scene image, x. Although in the embodiment of FIG. 2B, it is described that the scene image, x, is communicated to the encoder 204, which determines latent features of the complete image, in some embodiments of the present principles, the scene image, x, can be processed to separate multimodal components of a captured image.

For example, FIG. 2C depicts a functional diagram of the optional data analyzer 250, illustratively including the scene graph generator 251 and the scene caption generator 252, and the at least one encoder 204 of an edge device of the present principles in accordance with an alternate embodiment of the present principles. In the embodiment of FIG. 2C, the sensor(s) 202 captures a scene image, x. In the embodiment of FIG. 2C, the scene image, x, is separated into regular scene images, X_{I}, a graph representation, X_{G}, (illustratively a scene graph) of the images of the scene image, x, generated by the scene graph (SC) generator 251, and into scene captions, X_{C}, generated by the scene caption generator 252. In some embodiments, the scene graph generator 250 can parse the relevant semantic entities/concepts (e.g., objects, sensor measurements, etc.) and their relationships to form a local scene/knowledge graph representation, X_{G}. The scene images, X_{I}, the graph representation, X_{G}, and the scene captions, X_{C}, are communicated to respective encoders 204₁, 204₂, and 204₃, which determine respective latent features, Z_{I}, Z_{G}, and Z_{C}, of the scene images, X_{I}, the graph representation, X_{G}, and the scene captions, X_{C}. The respective latent features can then be combined for example, using ALIGN contrastive learning and/or HD similarity. Although in the embodiment of FIG. 2C, the optional data analyzer 250 only separates captured scene data into two multimodal components, in alternate embodiments of the present principles, captured scene data can include many other multimodal components (e.g., depth information) and the optional data analyzer 250 can include respective analyzers for analyzing such other multimodal components in the scene data and communicating such analyzed data to a respective encoder. The determined latent features can then be communicated to an inference module of an edge device of the present principles.

For example and referring back to FIG. 2B, the latent features determined by the encoder(s) 204 are communicated to the inference module 206, including the inference model 207 having been trained to make a prediction (i.e., identification of objects/characteristics, predict steps in a task, etc.) of the received scene image, x, from received latent features. The resource determination model 208 of the inference module 206 is trained to determine resources needed to enable the inference module 206 to make correct/accurate predictions from currently received data (described in greater detail below). For example, in some embodiments, the inference model 207 of the inference module 206 can include at least one of a classification model (e.g., scene classification/fine-grained classification/geolocation), a recommendation model (i.e., given a state, return relevant information; e.g., if mechanical failure of device, what set of things should a human/agent check to diagnose the problem?), and the like. In some embodiments, the resource determination model 208 can include an exploratory model (i.e., what do I need to do to gather more information; e.g., in sensor networks, what sensors should I ping in the next time step to reduce uncertainty about the state). That is, in the embodiment of FIG. 2B, the inference module 206, using the trained inference model 207, can predict a state of the scene image, x, using information in the received scene image, x, to determine if a correct/accurate prediction can be made from the data captured from related sensor(s) and to make such predictions when capable.

In addition, in embodiments of the present principles the inference module 206 can determine if Out-of-Distribution (OoD) data/features (e.g., different class, different image modality, different task, etc., from what the model 207 was trained) exist in the received latent features of the scene image, x. That is, in some embodiments, the inference model 207 of the inference module 206 can determine what type of predictions the inference model 207 of the inference module 206 can make based on the data used to previously train the inference model 207. As such, OoD data/features can be identified in received data/latent features of, for example, captured scene images.

More specifically, in some embodiments, the inference model 207 can be trained to recognize an OoD state of received data. That is, an ML model/system of the present principles, such as the inference model 207 of the inference module 206 of the edge device 110 of the edge device query-based knowledge assisted machine learning system 100 of FIG. 1, can be trained using a plurality (e.g., hundreds, thousands, millions) of instances of combinations of datasets containing in-distribution and out-of-distribution data and a success/failure of the inference model of the present principles to make predictions from the data based on the different in-distribution and out-of-distribution data combinations. For example, in some embodiments, during training, predictions of the inference model can be compared to ground truth predictions for the different combinations of in-distribution and out-of-distribution data to determine an effect of different combinations of in-distribution and out-of-distribution data on the accuracy of predictions of the inference model based on a comparison with ground truth predictions. In some embodiments, the inference model 207 of the inference module 206 can determine a degradation of an accuracy of predictions of the inference model 206 as OoD data is being detected until the predictions being made by the inference model 206 are not longer correct/acceptable, for example, against a predetermined threshold.

In some embodiments of the present principles, an OoD state and related OoD features can be identified by the inference model 207 of the inference module 206 using vector representations of, for example, latent features of captured scene data. For example, in some embodiments, at least a portion of information (e.g., a local knowledge graph) of a scene image, x, can be encoded into a vector-based representation(s). An inference model of the present principles, such as the inference model 207 of the inference module 206 of the edge device 110 of the edge device query-based knowledge assisted machine learning system 100 of FIG. 1, can then determine whether the state of the scene is compatible (e.g., in-distribution) with respect to the inference model 207 (e.g., classifier, reinforcement learning policy, etc.) of the inference module 206. If compatible, the inference model 207 can be implemented to generate a prediction/action from the captured scene data. If the state of the scene image, x, as reflected by at least the vector-based representation, is not compatible (e.g., out-of-distribution) with respect to the inference model 207, the edge device 110 can communicate an edge query, in some embodiments including the vector-based state representation, to a centralized server, such as the cloud server, to solicit the return of relevant data/resources to enable the inference model 207 of the inference module 206 to make correct/accurate predictions from the captured scene data.

In some embodiments of the present principles, an OoD score can be determined by the inference module 206 of the edge device 110 of the edge device query-based knowledge assisted machine learning system 100 of FIG. 1 based on an amount of OoD data/features identified in received data. In such embodiments, if an OoD score is above a predetermined threshold, the inference module 206 can generate an edge query to be communicated to the Cloud server 150, the edge query intended to elicit a response from the Cloud server 150 including resources needed to update the inference model 207 of the inference module of the edge device 110 to enable the inference model 207 to more accurately make a prediction from captured scene data.

Once the predictions being made by the inference module 206 are determined to be no longer correct/accurate by, for example the inference model 207, the resource determination model 208 of the present principles can implemented to recognize what additional resources (e.g., weights, data updates, adaptors, models, etc.) are needed to improve a prediction of the inference model and, in addition, how much a prediction of the inference model will improve based on what kind and how much additional resources are provided to adapt/update the inference model 207.

That is, in some embodiments, the resource determination model 208 of the inference module 206 of the edge device 110 of the edge device query-based knowledge assisted machine learning system 100 of FIG. 1, can be trained using a plurality (e.g., hundreds, thousands, millions) of instances of combinations of datasets containing in-distribution and out-of-distribution data and a trained inference model of the present principles to determine what additional data is required by the inference model to make correct/accurate predictions from captured data containing in-distribution and out-of-distribution data. As such, in accordance with the present principles, a resource determination model can be trained to determine at least a minimal amount of resources necessary to update the inference model to make a correct/accurate prediction for captured scene data.

That is, in some embodiments of the present principles, a resource determination model of the present principles, such as the resource determination model 208 of the inference module 206, can implement suitable machine learning techniques to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Seq2Seq’ Recurrent Neural Network (RNNs)/Long Short-Term Memory (LSTM) networks, Convolution Neural Networks (CNNs), graph neural networks applied to the abstract syntax trees corresponding to the sequential program application, Transformer networks, and the like. In some embodiments a supervised machine learning (ML) classifier/algorithm could be used such as, but not limited to, Multilayer Perceptron, Random Forest, Naive Bayes, Support Vector Machine, Logistic Regression and the like. In addition, in some embodiments, the inference model of the present principles can implement at least one of a sliding window or sequence-based techniques to analyze data.

Alternatively or in addition, in some embodiments, a resource determination model of the present principles, such as the resource determination model 208 of the inference module 206, instead of determining resources necessary for the inference model 207 to make correct/accurate predictions, can determine a copy of a current inference model 207 and information regarding current data being captured by associated sensors to be communicated to a data source, such as a difference edge device 110 or a server (cloud server 150), for determination at the data source of what resources are needed to update the inference model 207 to make correct/accurate predictions (described in greater detail below).

Referring back to the embodiment of FIG. 2B, in some embodiments the inference module 206 can generate an edge query for resources that can be communicated to a data source, such as another edge device 110 and/or the cloud server 150 in the form of a query model 210. In such embodiments, the edge query (e.g., query model 210) communicated to the data source, such as another edge device 110 or the cloud server 150, can identify, from information received in the edge query (query model 210), resources needed by the inference model 207 to more accurately make predictions from received captured scene data including the OoD data. Alternatively or in addition and as described above, in some embodiments of the present principles, an edge query (e.g., query model 210) communicated to a data source, such as another edge device 110 and/or the cloud server 150, can include at least one of information regarding captured OoD data from which the inference model 207 wants to make predictions and/or information regarding the current inference model 207 (i.e., from what captured data can the inference model 207 make accurate predictions) and, in such embodiments, resources required by the inference model 207 to be able to make accurate predictions from the captured data including the OoD data can be determined by the data source, such as another edge device 110 and/or the cloud server 150. In such embodiments the data source can include a trained machine learning model. (e.g., a resource determination model 208) to make such a determination.

As depicted in the embodiment of FIG. 2B, the edge queries (e.g., Query model 210) from the edge device 110, when communicated to the data source, such as another edge device 110 and/or the Cloud server 150, elicit a response, rᵢ, from the data source, in some embodiments, in the form of an inference model update 212, which can be used to update the inference model 207 of the inference module 206 of the edge device 110. In some embodiments of the present principles, the inference model update 212 can include resources that include, but are not limited to, at least one of data to be used by, for example, the inference module 206 to retrain the inference model 207 to be able to make accurate predictions using at least the identified OoD data, an adaptor to be applied to the inference model 207 to adapt the inference model 207 to be able to make accurate predictions from the identified OoD data, and/or an updated inference model to supplement or replace the inference model 207 of the inference module 206 to enable accurate predictions to be made by the updated inference model using at least the identified OoD data.

In some embodiments of the present principles, when an OoD state is identified by, for example, the inference model 207 of the inference module 206, additional data required for making an accurate prediction of captured data can also be obtained by adjusting capture parameters of at least one sensor communicating captured data to the edge device 110. For example, in some embodiments of the present principles, an edge device of the present principles, such as the edge device 110 of the edge device query-based knowledge assisted machine learning system 100 of FIG. 1, can further include an optional sensor adjustment module 214 as depicted in FIG. 2A. In such embodiments, when the inference model 207 of the inference module 206 determines that additional data is needed to accurately make a prediction, an edge query of the present principles can further be communicated to the sensor adjustment module 214 for adjusting capture parameters of at least one sensor communicating captured data to the edge device 110, to cause the sensor to adjust the capture parameters of the sensor to capture at least some of the additional data needed by the inference model 207 to accurately make a prediction.

In some embodiments of the present principles, an edge device of the present principles, such as the edge device 110 of the edge device query-based knowledge assisted machine learning system 100 of FIG. 1, can consider an available bandwidth between at least the edge device 110 and a data source, such as another edge device 110 and/or the cloud server 150, before communicating an edge query from the edge device 110 for needed resources. For example, in some embodiments, the edge device 110 can communicate to the cloud server 150 a variable length query vector that dynamically adjusts based on available bandwidth. For example, in some embodiments, the edge device can learn a query vector where a large percentage (e.g., 60%) of the edge query is stored in the first 64 elements, a smaller percentage (e.g., 20%) of the query request is stored in the next 64 elements, and an even smaller percentage (10%) of the query request is stored in the next number of elements, such that information can be chopped-off as needed (i.e., reduce the resolution of the query message) and additional data can be requested if needed. In such embodiments, a goal is to query the cloud server 150 for a smallest amount of informative samples to update the inference model 207 to enable the inference model 207 to make correct/accurate predictions.

In some embodiments to take into account bandwidth or available system resources, communications between the edge devices and/or the server are monitored and if either an edge device or a server determines that a communication and/or that data being communicated between the edge devices and/or the server is degrading, an amount of resources and/or a quality of resources being communicated can be reduced based on an available bandwidth and/or other system resources.

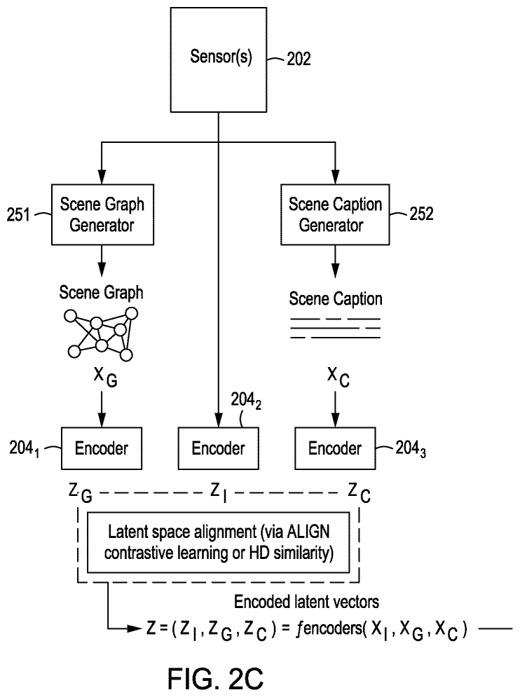

FIG. 3 depicts a graphical representation of a process that can take place at a data source, such as another edge device and/or the Cloud server 150, in response to an edge query in accordance with at least one embodiment of the present principles. The process of the embodiment of FIG. 3 is described with respect to a cloud server 150, however the process can take place at another data source, such as an edge device or another server. In the embodiment of FIG. 3, upon receiving an edge query, the cloud server 150 can determine what data/resources are needed by the edge device 110 based on the received edge query. That is, in some embodiments, in response to a receive edge query, qᵢ, the cloud server 150 can determine a cloud response model 310 indicative of the data/resources required by the inference model 207 of the inference module 206 of the edge device 110 to make a correct/accurate prediction using received, captured data. In some embodiments, the cloud server 150 can determine from a received edge query, qᵢ, a state of a relationship between an inference model 207 of the inference module 206 and the captured data to determine what resources are needed to make updates to the inference model 207 to enable the inference model 207 to make an accurate prediction based on the current, captured data, which may or may not include OoD data.

As depicted in the embodiment of FIG. 3, the data source, illustratively the cloud server 150, can retrieve the data/resources required by the edge device from a database 315 using a machine learning model 312 (e.g., auto-labeler) and/or with human assistance 312 for determining the cloud response model 310 to be communicated to the edge device 110. That is, in some embodiments, an edge query received at the cloud server 150 can be displayed on a display device associated with the cloud server 150 and a human can provide data and/or can search for and provide data from the database 315 to the cloud server 150 in response to the edge query received at the cloud server 150. For example, in some embodiments, a human can provide labels for objects in response to an edge query received at the cloud server 150. Alternatively or in addition, a human can search the database 315 for data/resources (e.g., missing images/data/information, adaptors, models, weights, and the like) in response to the edge query received at the cloud server 150.

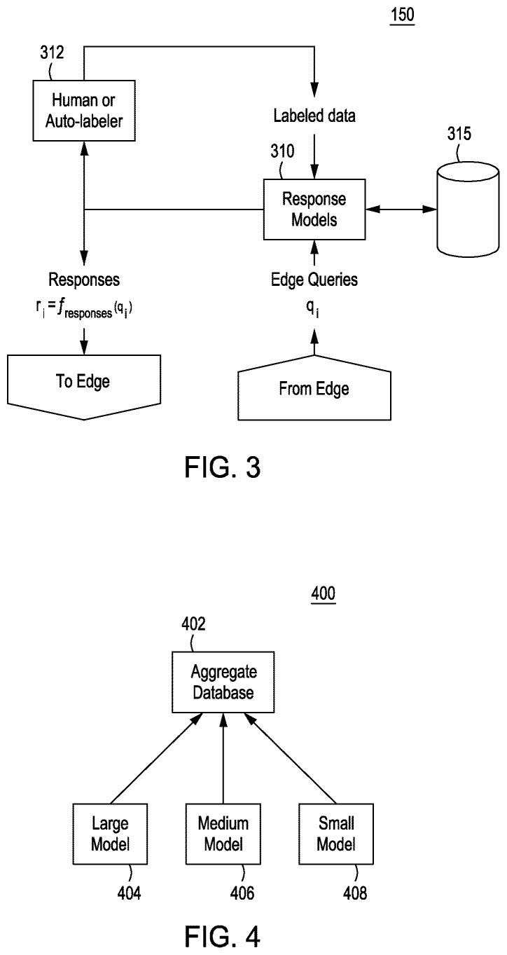

In some embodiments of the present principles, the database associated with the cloud server 150 can include a large model, such as a foundation model, that in accordance with the present principles can be made up of heterogeneous (at least one large and at least one small) models. FIG. 4 depicts a high-level block diagram of a database 315 of the present principles in accordance with at least one embodiment of the present principles. The database 315 of FIG. 4 illustratively comprises a large data model 404, a medium data model 406, and a small data model 408. As depicted in the embodiment of FIG. 4, the information from the large data model 404, the medium data model 406, and the small data model 408, in some embodiments, can comprise an aggregate data model 402. In some embodiments, the aggregate data model 402 can comprise a Foundation model. Generally, the larger the model, the better the intelligence/insights/generality of the model. However, on the flip side, the larger the model, the higher the cost of training and inference (after training) in terms of latency per query, energy consumption per query, memory required for training and running the model, amount of data required for training and total time and power consumption of training.

As such, in accordance with the present principles, the foundation model dataset 315 of FIG. 4 is trained efficiently by training the mixture of small 408, medium 406 and large 404 data models separately, without cross training. That is, the inventors determined that as long as there exists at least one large data model (even 1:10 ratio) and a plurality of small and/or medium data models forming an aggregate foundation model in accordance with the present principles, all models improve performance of all other models forming the aggregate data model. For example, in the embodiment of FIG. 4, the large data model 404, the medium data model 406, and the small data model 408 are trained locally without sharing data, avoiding the cost of data movement. An aggregate Foundation Model 402 (i.e., vision or non-vision foundation model) of the present principles can be trained with orders of magnitude lower total operations than the training of a state-of-the-art very large data models and an order of magnitude lower energy consumption. The mixture of small 408, medium 406 and large 404 models of the present principles is used to reduce inference cost of the aggregate Foundation Model 402 as well.

In the embodiment of the data set 315 of FIG. 4, the large data model 404 can leverage the training of smaller data models 406, 408. That is, in some embodiments, the information used to train the small data model 408 and the medium data model 406 can be implemented to help train the large model 404 and ultimately the aggregate model 402. For example, in some embodiments, weights used from training the small model 408 and the medium model 406 can be implemented in training the large model 404 and/or the foundation model 402. In the embodiment of FIG. 4, energy savings can be attributed to reduced operation and the smaller memory sizes.

In the embodiment of the dataset 315 of FIG. 4, the large data model 404, the medium data model 406 and the small data model 408 can each comprise a large GPU to be able to handle the data processing of the model. For additional energy savings and efficiency, the large data model 404, the medium data model 406 and the small data model 408 can each comprise different sized GPUs. For example, in one embodiment the large data model 404 can comprise a large GPU, the medium data model 406 can comprise a medium GPU, and the small data model 408 can comprise a small GPU. In such an embodiment of the present principles, additional energy savings can be attributed to the ability of the foundation model, formed by the large data model 404, the medium data model 406 and the small data model 408, to implement lower-end GPUs for the smaller models.

In alternate embodiments of the present principles, a heterogeneous foundation model of the present principles can be comprised from a network of edge devices such as depicted in the edge device query-based knowledge assisted machine learning systems of FIG. 1A, FIG. 1B, and FIG. 1C. More specifically, in some embodiments of the present principles, the edge devices 110₁, 110₂, and 110₃ can comprise heterogeneous models having at least one large model and two smaller-sized models. In such an embodiment, the server 150 can comprise an aggregate Foundation Model of the heterogenous edge devices.

In a foundation model of the present principles, energy savings can be captured by choosing a smaller model in which to search for information required instead of having to search through all models. For example, a foundation model of the present principles can keep track of the heterogenous attributes of each model and only search in a model with a desired heterogeneous attribute (i.e., best data match, highest fidelity, highest confidence score for particular data in question, and the like). As such, foundation model embodiments of the present principles can conserve additional energy over traditional large models in which the entire model has to be searched. For example, in some embodiments of the present principles, a finite state diagram of a foundation model of the present principles can be created (i.e., using edge devices as nodes and interconnections as edges) to keep track of data flow to enable to determine the data characteristics of a network of edge devices in accordance with the present principles. In some embodiments, such state diagram can include a server.

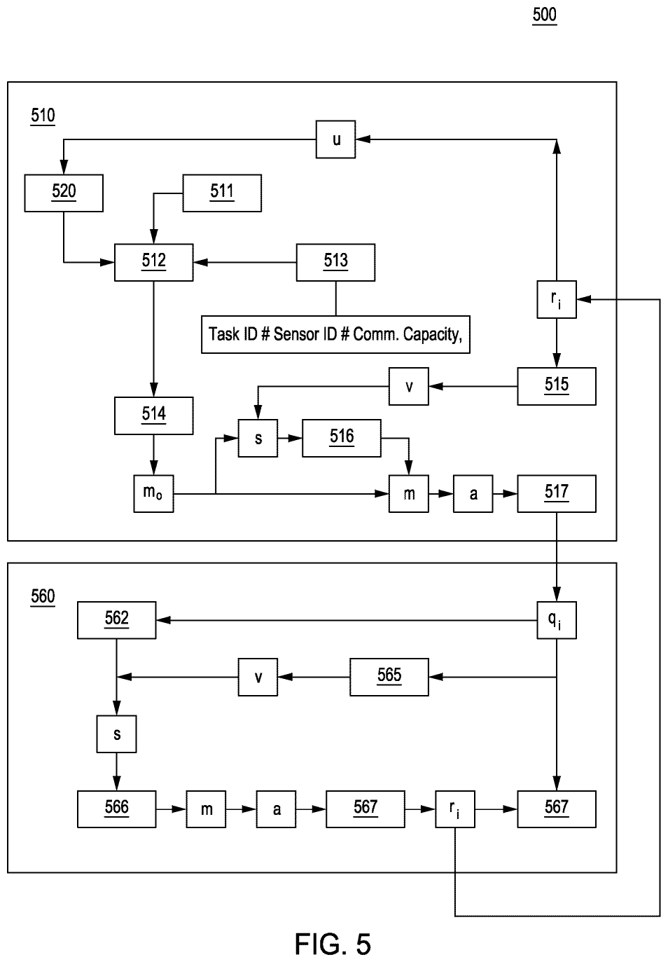

FIG. 5 depicts a high-level block diagram of an experimental embodiment of a full system architecture of an edge device query-based knowledge assisted machine learning system 500 in accordance with an embodiment of the present principles. The edge device query-based knowledge assisted machine learning system 500 of FIG. 5 illustratively includes an edge device architecture 510 and a cloud server architecture 560. In the embodiment of the edge device architecture 510 of FIG. 5, an initial dataset 511 captured by sensors associated with the edge device architecture 500 is communicated to the edge inference model module 512, which also receives input from an edge execution parameters module 513. That is, in the embodiment of the edge device query-based knowledge assisted machine learning system 500 of FIG. 5, the edge execution parameters module 513 annotates the initial dataset with non-neural network parameters, illustratively Task ID #, Sensor ID #, and communication capacity, c. The annotated initial dataset is communicated to a first edge message parameters generator module 514, which generates edge message parameters, m. In the embodiment of FIG. 5, an edge RL state, s, is added to the first edge message parameters, m₀, along with a cloud-message substate, v, generated by a cloud-to-edge message processor 515, which receives a cloud message input, rᵢ, from the cloud server architecture 560, described in greater detail below. The edge RL state, s, is processed by an edge message action RL model 516, to determine an RL action, a, to take, if any. The edge message parameters, m, information and the RL action, a, information are communicated to an edge message generator 517 to generate a message (e.g., edge query), qᵢ, to be communicated to the cloud server architecture 560.

At the cloud server architecture 560, a cloud execution parameters module 562 responds to the edge query, qᵢ, by obtaining the needed data from, for example, a database (not shown) in communication with the cloud server architecture 560. The cloud execution parameters module 562 annotates the retrieved data with non-neural network parameters, m, including a communication capacity, c. The annotated retrieved data is further annotated with a cloud RL state, s, and an edge-message substate, v, generated by an edge-to-cloud message processor 565, which also receives the edge message input, qᵢ, from the edge message generator 517 of the edge device architecture 510.

The cloud RL state, s, is processed by a cloud message action RL model 566, to determine a cloud RL action, a, to take, if any. The cloud message parameters, m, and the cloud RL action, a, information are communicated to a cloud message generator 567 to generate a cloud message, rᵢ, that is communicated to a reward module 568, which along with the edge message, qᵢ, is used to determine a reward. The reward module 568 can generate a reward based on at least an improvement of a prediction made by an updated inference model of the present principles and/or an amount of bandwidth used to communicate at least one of an edge query from an edge device to a centralized server and to communicate a cloud response to the edge device.

For example, in some embodiments a reward associated with reinforcement learning can be provided by monitoring a prediction of the trained inference model after an update and providing a reward to at least one of the edge device or the centralized server based on a result of the prediction of the trained inference model. Alternatively or in addition, in some embodiments a reward associated with reinforcement learning can be provided by monitoring communications between the edge device and the centralized server and providing a respective reward to at least one of the edge device or the centralized server based on an amount of bandwidth used for at least each communication request for the required resources.

With reference back to FIG. 5, the cloud message, rᵢ, is communicated back to the edge device architecture 510 in response to the edge message, qᵢ. With reference back to the edge device architecture 510 of FIG. 5, the cloud message, rᵢ, is communicated from the cloud server architecture 560 to the edge device architecture 510 of FIG. 5 as a model update, u, and the edge inference model updater module 520 updates a model of the edge inference model module 512 using the information in the cloud message, rᵢ.

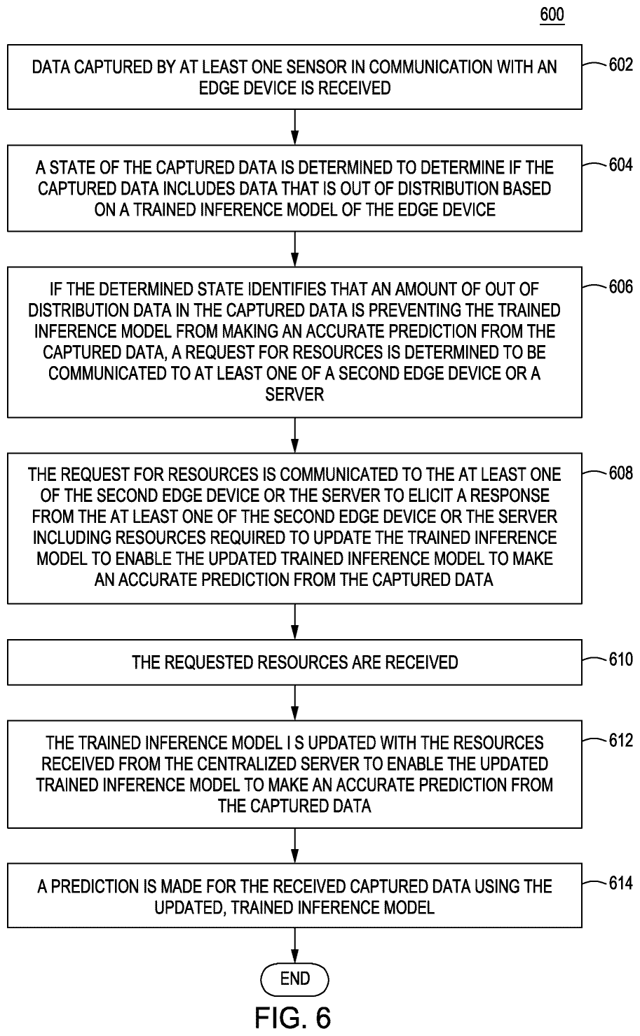

FIG. 6 depicts a flow diagram of a method 600 for efficient machine learning with query-based knowledge assistance on a first edge device in accordance with at least one embodiment of the present principles. The method 600 can begin at 602 during which data captured by at least one sensor in communication with the edge device is received. The method 600 can proceed to 604.

At 604, a state of the captured data is determined to determine if the captured data includes data that is out of distribution based on a trained inference model of the edge device. The method 600 can proceed to 606.

At 606, if the determined state identifies that an amount of out of distribution data in the captured data is preventing the trained inference model from making an accurate prediction from the captured data, a request for resources is determined to be communicated to at least one of a second edge device or a server. The method can proceed to 608.

At 608, the request for resources is communicated to the at least one of the second edge device or the server to elicit a response from the at least one of the second edge device or the server including resources required to update the trained inference model to enable the updated trained inference model to make an accurate prediction from the captured data. The method 600 can proceed to 610.

At 610, the requested resources are received. The method 600 can proceed to 612.

At 612, the trained inference model is updated with the resources received from the centralized server to enable the updated trained inference model to make an accurate prediction from the captured data. The method 600 can proceed to 614

At 614, a prediction is made for the received captured data using the updated, trained inference model. The method 600 can then be exited.

In some embodiments, the method further comprises identifying, in the request for resources, what resources are required to enable the trained inference model to make an accurate prediction from the captured data, wherein the required resources are determined using a second machine learning model of the first edge device.

In some embodiments, the request for resources enables the at least one of the second edge device or the server to determine what resources are required to enable the trained inference model to make an accurate prediction from the captured data, using a second learning model.

In some embodiments, the request for resources comprises at least information regarding the trained inference model and information regarding the captured data.

In some embodiments, the method further includes adjusting capture parameters of at least one of the at least one sensor to capture additional resources for updating the trained inference model.

In some embodiments, the server retrieves the required resources from a database comprising heterogeneous models including at least one large model and at least one smaller model, and wherein the database communicates resources to the server based on an available bandwidth between the database and the server.

In some embodiments, the first edge device retrieves the required resources from a network of heterogenous edge devices including at least one large model and at least one smaller model, and wherein at least one edge device of the network of edge devices communicates resources to the first edge device based on resource constraints of at least one of the first edge device or the edge devices of the network.

In some embodiments, the method further includes providing reinforcement learning by monitoring a prediction of the trained inference model after an update and providing a reward to at least one of the first edge device, the second edge device or the server based on a result of the prediction of the trained inference model.

In some embodiments, the request for the required resources is communicated to the centralized server based on a bandwidth available between the first edge device and at least one of the second edge device or the server at the time of the request. In such embodiments, the method can further include providing reinforcement learning by monitoring communications between the first edge device and at least one of the second edge device or the server and providing a respective reward to at least one of the first edge device, the second edge device or the server based on an amount of bandwidth used for at least each communication request for the required resources.

In some embodiments, the resources required to update the trained inference model to enable the updated trained inference model to make an accurate prediction from the captured data comprise at least one of data, weights, labels, adaptors, pretrained models, or model updates.

In some embodiments, an apparatus for efficient machine learning with query-based knowledge assistance on a first edge device includes a processor and a memory accessible to the processor. In such embodiments, the memory has stored therein at least one of programs or instructions, which when executed by the processor configures the apparatus to receive data captured by at least one sensor in communication with the first edge device, determine a state of the captured data to determine if the captured data includes data that is out of distribution based on/with a trained inference model of the first edge device, if the determined state identifies that an amount of out of distribution data in the captured data is preventing the trained inference model from making an accurate prediction from the captured data, determine a request for resources to be communicated to at least one of a second edge device or a server, communicate the request for resources to the at least one of the second edge device or the server to elicit a response from the at least one of the second edge device or the server including resources required to update the trained inference model to enable the updated trained inference model to make an accurate prediction from the captured data, receive the requested resources, update the trained inference model using the received resources to enable the updated trained inference model to make an accurate prediction from the captured data, and make a prediction for the received captured data using the updated, trained inference model.

In some embodiments, a system for efficient machine learning with query-based knowledge assistance on an edge device includes a server, a database in communication with the server, a network of edge devices, including at least two edge devices, wherein each edge device includes at least one sensor in communication and wherein each edge device includes a processor and a memory accessible to the processor. In such embodiments, the memory has stored therein at least one of programs or instructions that when executed by the processor configure a first edge device of the network of edge devices to receive data captured by at least one sensor in communication with the first edge device, determine a state of the captured data to determine if the captured data includes data that is out of distribution based on/with a trained inference model of the first edge device, if the determined state identifies that an amount of the out of distribution data in the captured data is preventing the trained inference model from making an accurate prediction from the captured data, determine a request for resources to be communicated to at least one of a second edge device of the network of edge devices or the server, communicate the request for resources to the at least one of the second edge device or the server to elicit a response from the at least one of the second edge device or the server including resources required to update the trained inference model to enable the updated trained inference model to make an accurate prediction from the captured data, receive the requested resources, update the trained inference model using the received resources to enable the updated trained inference model to make an accurate prediction from the captured data, and make a prediction for the received captured data using the updated, trained inference model.

As depicted in FIG. 2A, embodiments of edge devices of an edge device query-based knowledge assisted machine learning system of the present principles, such as the edge device query-based knowledge assisted machine learning system 100 of FIG. 1, can include a computing device 700 in accordance with the present principles. For example, FIG. 7 depicts a high-level block diagram of a computing device 700 suitable for use with embodiments of an edge device 110 of an edge device query-based knowledge assisted machine learning system of the present principles, such as the edge device query-based knowledge assisted machine learning system 100 of FIG. 1 in accordance with at least one embodiment of the present principles. In some embodiments, the computing device 700 can be configured to implement methods of the present principles as processor-executable program instructions 722 (e.g., program instructions executable by processor(s) 710) in various embodiments.

In the embodiment of FIG. 7, the computing device 700 includes one or more processors 710a-710n coupled to a system memory 720 via an input/output (I/O) interface 730. The computing device 700 further includes a network interface 740 coupled to I/O interface 730, and one or more input/output devices 750, such as cursor control device 760, keyboard 770, and display(s) 780. In various embodiments, a user interface can be generated and displayed on display 780. In some cases, it is contemplated that embodiments can be implemented using a single instance of computing device 700, while in other embodiments multiple such systems, or multiple nodes making up the computing device 700, can be configured to host different portions or instances of various embodiments. For example, in one embodiment some elements can be implemented via one or more nodes of the computing device 700 that are distinct from those nodes implementing other elements. In another example, multiple nodes may implement the computing device 700 in a distributed manner.

In different embodiments, the computing device 700 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 700 can be a uniprocessor system including one processor 710, or a multiprocessor system including several processors 710 (e.g., two, four, eight, or another suitable number). Processors 710 can be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 can be configured to store program instructions 722 and/or data 732 accessible by processor 710. In various embodiments, system memory 720 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 720. In other embodiments, program instructions and/or data can be received, sent or stored upon different types of computer-accessible media or on similar media separate from system memory 720 or computing device 700.

In one embodiment, I/O interface 730 can be configured to coordinate I/O traffic between processor 710, system memory 720, and any peripheral devices in the device, including network interface 740 or other peripheral interfaces, such as input/output devices 750. In some embodiments, I/O interface 730 can perform any necessary protocol, timing or other data transformations to convert data signals from one component (e.g., system memory 720) into a format suitable for use by another component (e.g., processor 710). In some embodiments, I/O interface 730 can include support for devices attached through various types of peripheral buses, such as a variant of the Peripheral Component Interconnect (PCI) bus standard or the Universal Serial Bus (USB) standard, for example. In some embodiments, the function of I/O interface 730 can be split into two or more separate components, such as a north bridge and a south bridge, for example. Also, in some embodiments some or all of the functionality of I/O interface 730, such as an interface to system memory 720, can be incorporated directly into processor 710.

Network interface 740 can be configured to allow data to be exchanged between the computing device 700 and other devices attached to a network (e.g., network 790), such as one or more external systems or between nodes of the computing device 700. In various embodiments, network 790 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 can, in some embodiments, include one or more display terminals, keyboards, keypads, touchpads, scanning devices, voice or optical recognition devices, or any other devices suitable for entering or accessing data by one or more computer systems. Multiple input/output devices 750 can be present in computer system or can be distributed on various nodes of the computing device 700. In some embodiments, similar input/output devices can be separate from the computing device 700 and can interact with one or more nodes of the computing device 700 through a wired or wireless connection, such as over network interface 740.

Those skilled in the art will appreciate that the computing device 700 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 700 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 700 can communicate with other computing devices based on various computer communication protocols such a Wi-Fi, Bluetooth.®. (and/or other standards for exchanging data over short distances includes protocols using short-wavelength radio transmissions), USB, Ethernet, cellular, an ultrasonic local area communication protocol, etc. The computing device 700 can further include a web browser.

Although the computing device 700 is depicted as a general-purpose computer, the computing device 700 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 700 can be transmitted to the computing device 700 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A method for efficient machine learning with query-based knowledge assistance on a first edge device, comprising:
receiving data captured by at least one sensor in communication with the first edge device;
determining a state of the captured data to determine if the captured data includes data that is out of distribution based on a trained inference model of the first edge device;
if the determined state identifies that an amount of out of distribution data in the captured data is preventing the trained inference model from making an accurate prediction from the captured data, determining a request for resources to be communicated to at least one of a second edge device or a server;
communicating the request for resources to the at least one of the second edge device or the server to elicit a response from the at least one of the second edge device or the server including resources required to update the trained inference model to enable the updated trained inference model to make an accurate prediction from the captured data;
receiving the requested resources;
updating the trained inference model using the received resources to enable the updated trained inference model to make an accurate prediction from the captured data; and
making a prediction for the received captured data using the updated, trained inference model.

2. The method of claim 1, further comprising identifying, in the request for resources, what resources are required to enable the trained inference model to make an accurate prediction from the captured data;
wherein the required resources are determined using a second machine learning model of the first edge device.

3. The method of claim 1, wherein the request for resources enables the at least one of the second edge device or the server to determine what resources are required to enable the trained inference model to make an accurate prediction from the captured data, using a second learning model.

4. The method of claim 3, wherein the request for resources comprises at least information regarding the trained inference model and information regarding the captured data.

5. The method of claim 1, further comprising:
adjusting capture parameters of at least one of the at least one sensor to capture additional resources for updating the trained inference model.

6. The method of claim 1, wherein the server retrieves the required resources from a database comprising heterogeneous models including at least one large model and at least one smaller model, and wherein the database communicates resources to the server based on an available bandwidth between the database and the server.

7. The method of claim 1, wherein the first edge device retrieves the required resources from a network of heterogenous edge devices including at least one large model and at least one smaller model, and wherein at least one edge device of the network of edge devices communicates resources to the first edge device based on resource constraints of at least one of the first edge device or the edge devices of the network.

8. The method of claim 6, wherein the at least one large model and at least one smaller model are independently trained without cross training.

9. The method of claim 7, wherein the at least one large model and at least one smaller model are independently trained without cross training.

10. The method of claim 1, further comprising:
providing reinforcement learning by monitoring a prediction of the trained inference model after an update and providing a reward to at least one of the first edge device, the second edge device or the server based on a result of the prediction of the trained inference model.

11. The method of claim 1, wherein the request for the required resources is communicated to the server based on a bandwidth available between the first edge device and at least one of the second edge device or the server at the time of the request.

12. The method of claim 11, further comprising:
providing reinforcement learning by monitoring communications between the first edge device and at least one of the second edge device or the server and providing a respective reward to at least one of the first edge device, the second edge device or the server based on an amount of bandwidth used for at least each communication request for the required resources.

13. An apparatus for efficient machine learning with query-based knowledge assistance on a first edge device, comprising:
a processor; and
a memory accessible to the processor, the memory having stored therein at least one of programs or instructions executable by the processor to configure the apparatus to:
receive data captured by at least one sensor in communication with the first edge device;
determine a state of the captured data to determine if the captured data includes data that is out of distribution based on a trained inference model of the first edge device;
if the determined state identifies that an amount of out of distribution data in the captured data is preventing the trained inference model from making an accurate prediction from the captured data, determine a request for resources to be communicated to at least one of a second edge device or a server;
communicate the request for resources to the at least one of the second edge device or the server to elicit a response from the at least one of the second edge device or the server including resources required to update the trained inference model to enable the updated trained inference model to make an accurate prediction from the captured data;
receive the requested resources;
update the trained inference model using the received resources to enable the updated trained inference model to make an accurate prediction from the captured data; and
make a prediction for the received captured data using the updated, trained inference model.

14. The apparatus of claim 13, wherein the apparatus is further configured to: identify, in the request for resources, what resources are required to enable the trained inference model to make an accurate prediction from the captured data;
wherein the required resources are determined using a second machine learning model of the first edge device.

15. The apparatus of claim 13, wherein the request for resources enables the at least one of the second edge device or the server to determine what resources are required to enable the trained inference model to make an accurate prediction from the captured data, using a second learning model.

16. The apparatus of claim 15, wherein the request for resources comprises at least information regarding the trained inference model and information regarding the captured data.

17. The apparatus of claim 13, wherein the apparatus is further configured to:
adjust capture parameters of at least one of the at least one sensor to capture additional resources for updating the trained inference model.

18. The apparatus of claim 13, wherein the server retrieves the required resources from a database comprising heterogeneous models including at least one large model and at least one smaller model, and wherein the database communicates resources to the server based on an available bandwidth between the database and the server.

19. The apparatus of claim 13, wherein the first edge device retrieves the required resources from a network of heterogenous edge devices including at least one large model and at least one smaller model, and wherein at least one edge device of the network of edge devices communicates resources to the first edge device based on resource constraints of at least one of the first edge device or the edge devices of the network.

20. The apparatus of claim 13, wherein the apparatus is further configured to:
provide reinforcement learning by monitoring a prediction of the trained inference model after an update and providing a reward to at least one of the first edge device, the second edge device or the server based on a result of the prediction of the trained inference model.

21. The apparatus of claim 13, wherein the request for the required resources is communicated to the server based on a bandwidth available between the first edge device and at least one of the second edge device or the server at the time of the request.

22. The apparatus of claim 21, wherein the apparatus is further configured to:
provide reinforcement learning by monitoring communications between the first edge device and at least one of the second edge device or the server and providing a respective reward to at least one of the first edge device, the second edge device or the server based on an amount of bandwidth used for at least each communication request for the required resources.

23. The apparatus of claim 13, wherein the resources required to update the trained inference model to enable the updated trained inference model to make an accurate prediction from the captured data comprise at least one of data, weights, labels, adaptors, pretrained models, or model updates.

24. A system for efficient machine learning with query-based knowledge assistance on an edge device, comprising:
a server;
a database in communication with the server;
a network of edge devices, including at least two edge devices, wherein each edge device includes at least one sensor in communication and wherein each edge device comprises:
a processor; and
a memory accessible to the processor, the memory having stored therein at least one of programs or instructions executable by the processor to configure at least one first edge device of the network of edge devices to:
receive data captured by at least one sensor in communication with the first edge device;
determine a state of the captured data to determine if the captured data includes data that is out of distribution based on a trained inference model of the first edge device;
if the determined state identifies that an amount of the out of distribution data in the captured data is preventing the trained inference model from making an accurate prediction from the captured data, determine a request for resources to be communicated to at least one of a second edge device of the network of edge devices or the server;
communicate the request for resources to the at least one of the second edge device or the server to elicit a response from the at least one of the second edge device or the server including resources required to update the trained inference model to enable the updated trained inference model to make an accurate prediction from the captured data; receive the requested resources;
update the trained inference model using the received resources to enable the updated trained inference model to make an accurate prediction from the captured data; and
make a prediction for the received captured data using the updated, trained inference model.

25. The system of claim 24, wherein the first edge device is further configured to: identify, in the request for resources, what resources are required to enable the trained inference model to make an accurate prediction from the captured data;
wherein the required resources are determined using a second machine learning model of the first edge device.

26. The system of claim 24, wherein the request for resources enables the at least one of the second edge device or the server to determine what resources are required to enable the trained inference model to make an accurate prediction from the captured data, using a second learning model.

27. The system of claim 26, wherein the request for resources comprises at least information regarding the trained inference model and information regarding the captured data.

28. The system of claim 24, wherein the first edge device is further configured to:
adjust capture parameters of at least one of the at least one sensor to capture additional resources for updating the trained inference model.

29. The system of claim 24, wherein the server retrieves the required resources from the database, which comprises heterogeneous models including at least one large model and at least one smaller model that communicate resources to the server based on an available bandwidth between the database and the server.

30. The system of claim 24, wherein the network of edge devices comprise heterogenous edge devices including at least one large model and at least one smaller model.

31. The system of claim 24, wherein the first edge device is further configured to:
provide reinforcement learning by monitoring a prediction of the trained inference model after an update and providing a reward to at least one of the first edge device, the second edge device or the server based on a result of the prediction of the trained inference model.

32. The system of claim 24, wherein the request for the required resources is communicated to the server based on a bandwidth available between the first edge device and at least one of the second edge device or the server at the time of the request.

33. The system of claim 32, wherein the first edge device is further configured to:
provide reinforcement learning by monitoring communications between the first edge device and at least one of the second edge device or the server and providing a respective reward to at least one of the first edge device, the second edge device or the server based on an amount of bandwidth used for at least each communication request for the required resources.

34. The system of claim 24, wherein the resources required to update the trained inference model to enable the updated trained inference model to make an accurate prediction from the captured data comprise at least one of data, weights, labels, adaptors, pretrained models, or model updates.
